(19) United States
(12) Patent Application Publication
(10) Pub. No.: US 2002/0063103 A1
(43) Pub. Date: May 30, 2002

(54) Nipple for nursing bottle

(76) Inventor: Kathleen Kiernan, Madison, NJ (US)

Correspondence Address: Thomas L. Adams, P.O. Box 340, East Hanover, NJ, 07936, US

(21) Appl. No.: 10/047,771

(22) Filed: Oct. 23, 2001

Related U.S. Application Data
(63) Continuation-in-part of application No. 09/459,583, filed on Dec. 13, 1999, now abandoned.

(51) Int. Cl. A61J 9/00; A61J 17/00

(52) U.S. Cl. 215/11.4; 606/236

(57) ABSTRACT

A nursing bottle nipple provides controlled and limited liquid flow by providing an opening in the nipple of fluid flow restricting small size and a partition diaphragm in the nipple cavity with a second opening also for restricting liquid flow. The two openings cooperate to limit liquid flow in response to the suction created by a baby. The partition opening is larger than the nipple opening to permit the desired fluid flow due to the reduced pressure drop across the partition created by the restricted opening size in the nipple body. The partition forms a small chamber in the nipple to limit the volume of liquid that a baby can withdraw at a time. Different embodiments are disclosed wherein the opening in the partition may be a hole of different shapes or a slit, or it may be a separate element attached to the nipple by the ring cap. The slit opens into an opening of a desired magnitude by flexure of the partition in response to the suction pressure differential thereacross. Different diaphragms may have different positions in the nipple forming different chamber sizes. The nipple and diaphragm may both be cylindrical and subject to distortion by mastication by the baby during sucking to both open up or further close the diaphragm opening.

This application is a continuation-in-part of U.S. patent application Ser. No. 09/459,583, filed Dec. 13, 1999, and entitled Nipple for Nursing Bottle.

### BACKGROUND OF THE INVENTION

1. Field of the Invention

The present invention relates to nursing bottle nipples.

2. Description of Related Art

Conventional nipples in wide use comprise thermoplastic or other pliable materials molded as one piece with a funnel configuration terminating at a flange at the wider open end for securing the nipple to a nursing bottle via a clamping ring. Typically, such nipples are shaped somewhat similarly to a mother's nipple with a restricted opening at the nipple end opposite the flange.

U.S. Pat. Nos. 4,993,568 and 5,101,991 disclose a nipple for a nursing bottle made of soft elastic material with a front mouthpiece portion and a fitting clamped by a clamping ring. The nipple front mouthpiece portion has a relatively wide open sucking aperture. A partition wall has a milk sucking hole integrally formed in the interior of the nipple. The partition is located in a region corresponding to a mother's areola region of the breast so that it can be deformed by a masticating force exerted by the upper and lower jaws of a baby. This is to simulate the function of a mother's nipple and to teach the baby to use its jaws to help suck the milk from the bottle.

U.S. Pat. No. 5,601,199 discloses a filter element for a beverage container such as a nursing bottle. The filter element is provided with a plurality of holes each of which is smaller than the outlet opening. The filter in one embodiment has two discs overlying each other which can be relatively rotated between an open state and a closed state according to the relative alignment of the holes in the discs. This filter is located far from the nipple region out of the region where masticating forces can be applied.

U.S. Pat. No. 5,791,503 discloses a nursing bottle with an anti-air ingestion valve located between the nipple and the bottle. U.S. Design Pat. No. 330,938 discloses a nipple whose function is not explained. U.S. Pat. No. 5,609,759 discloses a bottle filter cap.

The present inventor recognizes a need to prevent a baby from sucking too high a volume of liquid as occurs in present nipples. That is, in all of the above patents there is no recognition of a problem wherein when the baby sucks, it may provide excessive pressure and draw too much liquid at a time. For example, in the prior art noted above, in nipples employing an opening only in the nipple body front, no matter how small the opening, the baby tends to suck on the pliable material and open the opening substantially, creating a liquid flow that is excessive for the baby's capacity to swallow and thus may gag or choke the baby on the liquid flow.

In the patents noted above, there is no recognition of this choking problem and therefore there is provided no solution thereto. For example, in the U.S. Pat. Nos. 4,993,568 and 5,101,991, a relatively wide open outlet port is provided in cooperation with an interior partition with a relatively smaller opening formed by a slit in the partition. In these patents, it is disclosed that the partition opening comprise a slit which is normally closed and does not open unless the partition is masticated by the baby's jaws. The idea is that no milk can be drawn from the bottle unless the baby also flexes the partition to open the slit therein. Once the slit is opened, the baby can then suck the liquid through the relatively large front exterior opening.

This approaches the problem differently than the present invention. That is, the baby can only draw milk from the bottle by working the partition with its jaws and simultaneously sucking the milk from the bottle through the partition via the larger nipple open front. These patents do not describe the slit in the partition as opening only in response to the sucking action. This is believed unsatisfactory in certain circumstances where it is desired for the baby to draw the milk only by sucking action. In the latter case, the prior art nipples may cause choking due to excessive volume as discussed above. Also, once the baby's jaws open the slit, the baby still may be able to draw excessive milk through the open slit and choke. The slit in the partition may not limit the flow once it is opened by the jaws to an amount that prevents the baby from choking.

### SUMMARY OF THE INVENTION

In accordance with the illustrative embodiments demonstrating features and advantages of the present invention, there is provided a nursing bottle nipple for insertion past the lips of an infant and into the infant's mouth. The nipple includes a pliable nipple body having a nipple portion and an intermediate portion flaring radially outward from the nipple portion. The intermediate portion is sized and flared to intercept the infant's lips and prevent further insertion of the nipple body into the infant's mouth. The pliable nipple body has a hollow interior with a wide proximal open end and a narrower distal end. The distal end has when undistorted at least one first aperture of a first transverse area for providing fluid communication between the body interior and the body exterior. Also included is an annular flange extending radially outwardly from the intermediate portion of the body at the body proximal open end for securing the body to a nursing bottle. The nipple also includes a diaphragm in the body interior forming a fluid receiving chamber in the body interior between the diaphragm and the distal end. The diaphragm includes a second aperture having when undistorted a second transverse area greater than the first transverse area for providing fluid communication between the proximal end and the chamber. The at least one first aperture and the second aperture each have a maximum transverse area such that each aperture restricts liquid flow therethrough in response to a sucking action on the distal end externally the nipple body to cooperatively limit the flow of liquid therethrough. The diaphragm is spaced distally from the intermediate portion to place the diaphragm between or past the infant's lips.

Preferably the body, flange and diaphragm are one piece molded material.

Preferably the at least one first aperture comprises a plurality of apertures of substantially the same transverse area and more preferably the at least one first aperture comprises an array of at least three relatively small apertures.

In a further aspect, the at least one first aperture comprises a normally closed slit which opens in response to flexure of the body.

Preferably the second aperture comprises a circular hole.

In a further aspect, the second aperture comprises a slit that is normally closed and wherein the diaphragm is pliable and flexes the slit open in response to flexure thereof, the slit when open forming an opening larger than the at least one first aperture.

The slit may comprise a plurality of slits in the diaphragm. More preferably, the slits extend radially across the diaphragm in a pie-shaped configuration.

The chamber preferably holds about ⅕ fluid ounce.

In a further aspect, the diaphragm tapers from a maximum thickness at the body to a minimum thickness at the second aperture.

In a still further aspect, the relative areas of the at least one first aperture and the second aperture is such that liquid collects in the chamber in response to the sucking action.

In a further aspect, the nursing bottle nipple comprises a pliable nipple body having a hollow interior with a relatively wide proximal open end and a narrower distal end. The distal end has at least one first aperture of a first transverse area for providing fluid communication between the body interior and the body exterior. An annular flange extends radially outwardly from the body at the body proximal open end for securing the body to a nursing bottle. A partition is located in the body interior and forms a liquid receiving chamber in the body between the partition and the distal end. The partition has a second aperture of a second transverse area for providing fluid communication between the chamber and the proximal end. The at least one first aperture and the second aperture each have a maximum transverse area that restricts relative liquid flow through each of the apertures as the liquid flows from the proximal end through the second and at least one first apertures in response to a sucking action on the distal end, such that liquid flow into the chamber through the second aperture cooperates with the flow from the chamber through the at least one aperture in response to the sucking action, and such that liquid collects in the chamber.

The second aperture in a further aspect comprises a slit that is normally closed and wherein the partition is pliable and flexes the slit open in response to a flexure force, the slit when open forming an opening larger than the at least one first aperture.

In a further aspect, the diaphragm is located in the nipple body such that the diaphragm is subject to distortion forces by mastication by a baby sucking on the nipple.

In a further aspect, the diaphragm is located in the nipple body such that the diaphragm aperture is subject to increased opening and decreased opening by mastication distortion by a baby sucking on the nipple.

In a further aspect, the diaphragm includes a conduit portion extending from a further flange, the conduit portion having a restricted end and an open end, the second aperture being disposed in the restricted conduit portion end.

In a further aspect, means are provided for setting the spacing of the diaphragm to the at least one first aperture in the body distal end to thereby set the volume of the chamber to a predetermined value.

The body chamber in a further aspect is circular cylindrical with a given diameter, the conduit portion being circular cylindrical and having a diameter closely received in the chamber to form a fluid seal at the interface of the conduit portion with the body at the chamber.

Preferably, the body has a cylindrical nipple portion and a flange coupling portion for coupling the nipple portion to the annular flange, the coupling portion including an undulating section between the nipple portion and the annular flange, the nipple portion extending from the coupling portion, and the undulation section having an annular channel extending about the nipple portion.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is fragmented, sectional, elevational view of a nipple according to one embodiment of the present invention taken along lines 1-1 of FIG. 2;

FIG. 2 is a plan view of a nipple and bottle assembly of the present invention;

FIG. 3 is fragmented, sectional, elevational view of a nipple similar to the view of FIG. 1 showing a nipple in more detail for explaining certain principles of the present invention;

FIG. 4 is a plan sectional view of a partition diaphragm according to a second embodiment;

FIG. 5 is a plan view of a nipple and bottle assembly according to a second embodiment;

FIGS. 6-8 are plan views of alternate embodiments of a partition diaphragm hole;

FIGS. 9 and 10 are sectional, elevational views of portions of alternate embodiments of a nipple of the present invention; and

FIGS. 11-13 are side elevation sectional views of further embodiments of a differently configured nipple and mating diaphragms for limiting liquid flow in response to suction and for presetting different chamber sizes for receiving liquid during suction action.

### DETAILED DESCRIPTION OF THE PREFERRED EMBODIMENTS

Referring to FIG. 1, nipple-bottle assembly 2 of the present invention comprises a nursing bottle 4 of conventional design and typically molded thermoplastic clear or translucent material. The bottle 4 has an opening 6 formed by collar 8. External threads 10 are formed in the outer surface of the collar 8. A clamping ring 12, generally also molded thermoplastic material, has internal threads 14 and a radially inwardly extending flange 16 defining a central opening 18. All of the above elements are conventional.

Nipple 20 of the present invention is preferably formed of pliable thin elastomeric or thermoplastic material as in conventional nipples. Nipple 20 has a somewhat funnel-like configuration that tapers from an open wide proximal end 22 to a narrower distal end 24. End 24 preferably is somewhat semispherical, but may have other shapes such as cylindrical or others. End 24 may in this embodiment have a somewhat circular cylindrical sidewall 26 which may also taper in other embodiments which is not important. The sidewall 26 tapers at sidewall 28 somewhat as a frustro-conical configuration to lower sidewall 30. This transition is also referred to as flaring by an intermediate portion 28 to provide a larger region acting as stop to limit insertion of nipple portion 26 of nipple body 2 into an infant's mouth (the lips L of said infant's mouth being shown in phantom in FIG. 1). The sidewall 30 defines a large bottom opening 32.

An annular flange 34 extends radially outwardly from sidewall 30 and rests on the upper edge of the bottle collar 8 to which it is clamped by clamping ring 12 in conventional fashion. An annular rib 36 extends from the outer surface of sidewall 28 at the interface with wall 30 to form a channel 38. The flange 16 of the clamping ring 12 snaps into the channel 38 to releasably secure the nipple 20 to the ring 12.

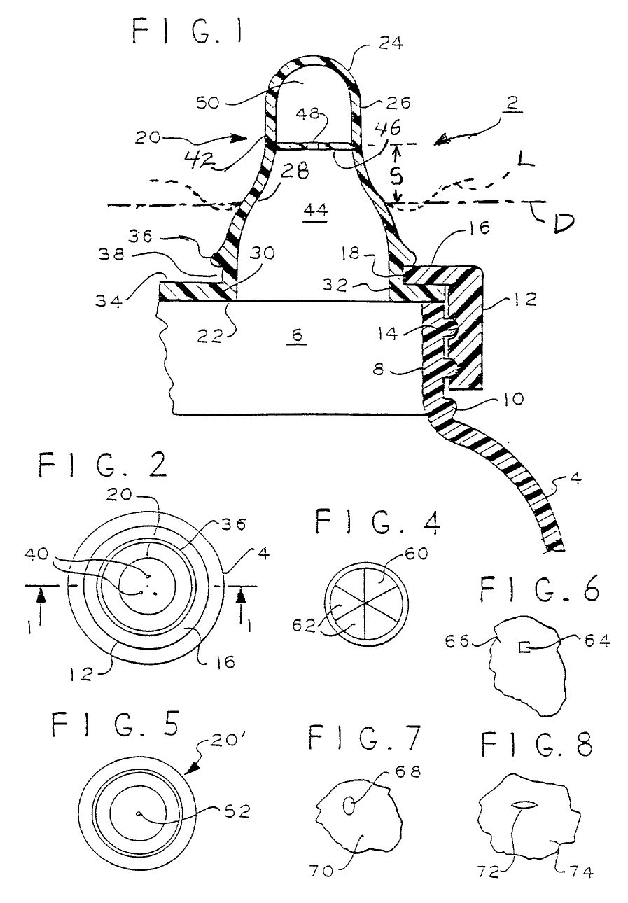

The nipple 20 at its distal end 24 has an array of three pin hole apertures 40, FIG. 2, not visible in FIG. 1. A partition diaphragm 46, is preferably molded integral and one piece with the nipple 20 body 42 at either sidewall 26 or 28 or the junction thereof in the nipple interior 44. Diaphragm 46 has a central aperture 48. The diaphragm 46 forms a liquid receiving chamber 50 with the nipple 20 interior 44. The diaphragm may be a separately attached member if desired.

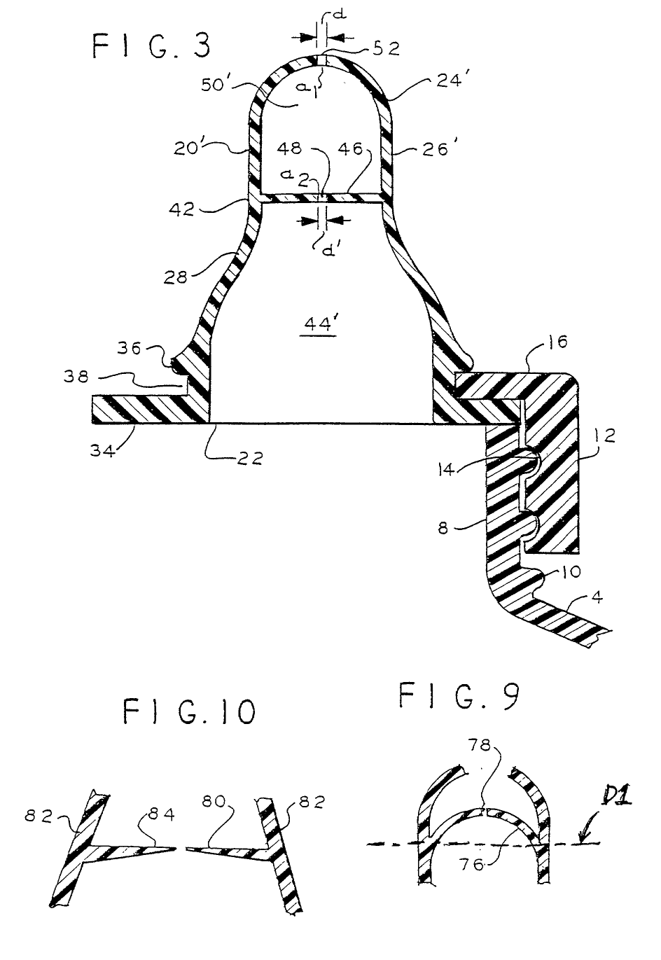

In FIGS. 3 and 5, nipple 20′ is substantially the same as nipple 20, FIG. 1, except the nipple 20′ has one aperture 52 instead of three apertures 40, FIG. 2, in the nipple 20. The primed reference numerals in FIG. 3 represent the same elements as the elements in FIG. 1 that have reference numerals that are unprimed. The three apertures 40 of nipple 20 have and define an effective combined transverse open area the same as the aperture 52 transverse area a₁ of nipple 20′, FIG. 3. The aperture 52 has a diameter d.

This diameter d is relatively small and may be referred to as a pin hole in the order of about 0.005-0.100 inches in diameter, which is given by way of example. Aperture 52 may be larger also. The diameter of the aperture depends upon the flexibility of the nipple material and the flow rate desired, taking the age of the infant into account. The more flexible the material the smaller the aperture may be. The three apertures 40, FIG. 2, have the functional equivalent total combined effective size as the aperture 52. These relative dimensions can be determined empirically by one of ordinary skill in this art. While three nipple apertures 40 are preferred, a single aperture 52 will be explained for simplicity of illustration.

The diaphragm 46 has a central aperture 48 which has a diameter d′, FIG. 3, that is larger than the effective opening size of the three apertures 40 or the diameter d of aperture 52, FIG. 3. The effective open area a₁ of aperture 52 is smaller than the effective open area a₂ of the aperture 48 of the diaphragm.

In operation, when a baby applies a suction to the nipple 20 or 20′, the apertures 40 or 52 provide an equivalent restriction to the flow of liquid therethrough. The bottle at this time is inverted from the orientation shown so that liquid flows against the diaphragm 46. The suction is transferred via the chamber 50 or 50′ to the aperture 48 in the diaphragm 46. The relatively larger aperture 48 area a₂ of diameter d′ provides a relatively high fluid flow into the chamber 50 or 50′. This tends to fill the chamber 50 or 50′. However, at the same time, the suction is removing liquid from the chamber through the restriction of the nipple 20 or 20′ apertures 40 or 52, respectively.

The nipple apertures 40 or 52 provide restricted fluid flow therethrough as does the diaphragm aperture 48 although the latter aperture is less restrictive than the former apertures. The apertures 40 or 52 cooperate with the aperture 48 to limit and restrict the flow of liquid in response to suction on the nipple 20 or 20′. That is, the force produced by the suction in the chamber is attenuated further by the restriction created by the aperture in the diaphragm. The diaphragm aperture 48 is made larger because the restriction of the aperture 52 creates a pressure drop thereacross in the chamber 50. Thus the suction in the chamber 50 or 50′ has a reduced magnitude with respect to the initial suction value produced externally the nipple 20 or 20′.

In order to provide the desired flow through the diaphragm 46 aperture 48, its aperture is increased in size since the pressure drop across the diaphragm is reduced from that across the apertures 40 or 52. Thus the apertures 40 and 52 cooperate with the aperture 48 to transfer the total pressure drop external the nipple to the bottle interior in graduated steps to reduce the total flow out of the nipple. This prevents or minimizes gagging or choking of the baby.

The chamber 50 or 50′ preferably is about ⅕ an ounce of fluid to further minimize the amount of fluid that the baby can withdraw from the chamber into its mouth. The ⅕ ounce is believed sufficiently small to preclude choking even if withdrawn at a relatively high flow rate. Even if the fluid is withdrawn at a relatively high rate from the chamber, the restricted flow through the diaphragm aperture at the thus reduced pressure drop thereacross will cause the chamber to fill at a slower rate than the withdrawal rate from the nipple aperture 40 or 52 due to the thus reduced pressure drop.

In other words, the total drop in pressure across the nipple and bottle interior has a certain value A. If the drop value between the baby and the chamber 50 or 50′ is a larger portion of the total pressure drop, e.g., 70% of A, a smaller portion of that drop, e.g., 30% of A is between the chamber and the bottle interior, slowing down the flow to the chamber from the bottle. The larger diaphragm aperture 48 thus accommodates this reduced pressure drop to permit an acceptable flow rate into the chamber 50 or 50′. Thus it is important that both sets of apertures through the nipple body 42 and through the diaphragm restrict the flow rate to cooperatively prevent choking the baby. None of the prior art nipples provide cooperating apertures with restrictive flow rates for dividing the pressure drop in the manner of the present invention to thereby limit the total flow to the baby from the bottle.

In addition, in some embodiments, by placing the diaphragm in the nipple 20 interior adjacent to the closed distal end 24, such as shown in FIGS. 1 and 3, the baby's jaws may also masticate the nipple 20 body distorting the diaphragm 46. This distortion can flex the aperture 48 in the diaphragm further open or further close the aperture. This distortion also assists in controlling the flow of liquid from the end to the chamber 50. This distortion is a result of the location of the diaphragm in the nipple body interior. Thus by predetermining the location of the diaphragm in the nipple body further action in controlling the liquid flow may be enhanced.

The diaphragm 46 is shown positioned in FIG. 1 to permit deformation of diaphragm 46 by pressure exerted from the infant's lips L. The flaring of intermediate portion 28 limits nipple portion 26 to a depth of insertion marked by insertion border D. As shown in FIG. 1 the insertion depth is measured from the tip of the nipple to insertion border D, which is the proximal limit where the infant's lips L stop touching the nipple body 2. Generally, the infant will not accept portions of the nipple body 2 that are greater than approximately 1.0 in. (2.5 cm) in diameter. In practical embodiments the maximum diameter accepted by an infant less than six months old will be in the range of 0.50 in. to 1.0 in. (1.3 cm to 2.5 cm); and for older infants 0.75 in. to 1.25 in. (1.9 cm to 3.2 cm). Any diameter in excess of 1.50 in. (3.1 cm) will definitely act as a stop for the infant's lips and mouth. Of course, the effective limiting diameter will vary depending on the age and size of the infant, the genetically different sizes of the individual mouth openings, the infant's sucking habits, etc.

To be considered “between” the infant's lips L, diaphragm 46 should be inserted at least as far as the apex of the lips L. This apex is the portion of the lips L that first touch when the mouth of the infant first closes (absent a nipple). Such diaphragm placement will allow the infant to readily deform diaphragm 46 by applying lip pressure to the diaphragm. Diaphragm 46 can be placed even deeper into the infant's mouth to permit more direct deformation by the infant's jaw. To ensure placement of diaphragm 46 “between” the lips L or deeper, the distance S between insertion border D and the center of diaphragm 46 should be at least ⅛ in. (0.32 cm). To keep diaphragm 46 in a region where the infant can effectively deform the diaphragm, distance S should be no more than 1.0 in. (2.5 cm).

In the embodiment of FIG. 1, the diameter at insertion border D is 1.0 in. (2.5 cm), which constitutes the typical limit for insertion into an infant's mouth. The distance S is about 0.5 in., which places diaphragm 46 past the apex of lips L (that is, deeper than merely between the lips). If distance S was ⅛ in. (0.32 cm) diaphragm 46 would typically be “between” lips L (that is, at or just past the apex of lips L). Other embodiments discussed below may be readily adaptable for such selective location of the diaphragm in the nipple body to control the chamber 50 volume to a predetermined value.

In FIG. 4, for example, the diaphragm 60 comprises a plurality of pie-shaped segments 62. The segments 62 are formed by cuts or slits in a disc and terminate at their apex in contiguous relation. As a pressure drop is presented across the segments, the segments 62 flex creating a space therebetween for flowing liquid into the chamber between the diaphragm and the nipple body at the nipple distal end at the suction tip. This created space has a total area greater than the nipple distal end apertures such as apertures 40 or 52.

In FIGS. 6-8, the diaphragm apertures may be square as aperture 64 in diaphragm 66, oval as aperture 68 in diaphragm 70 or elongated as in aperture 72 of diaphragm 74.

In FIG. 9, diaphragm 76 in an alternative embodiment is an upwardly curved convex shape with a central aperture 78 which may also be a slit. The diaphragm 76 aperture 78 if a slit is opened due to flexure of the diaphragm in response to the pressure differential thereacross, the diaphragm being relatively thin material which easily flexes, the drawings not being to scale. For determining the depth of insertion of diaphragm 76, one would measure from the junction of the diaphragm and the supporting sidewall, that is, from insertion border D1.

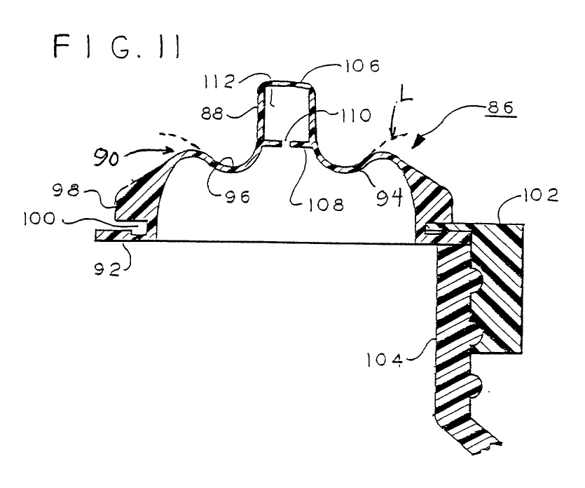

In FIG. 10, diaphragm 80 has a tapered thickness with the thicker portion at the nipple body sidewall 82 and the thinnest portion at the aperture 84. In this way the aperture may be opened larger by flexure of the diaphragm.

In FIG. 11, pliable, preferably molded one piece thermoplastic or elastomeric material nipple 86 comprises preferably a circular cylindrical nipple portion 88. The portion 88 extends from an intermediate portion 90 which extends radially inwardly from annular flange 92. The flange portion 90 has an annular undulation 94 forming a channel 96 about the nipple portion 88. Channel 96 presents a definite wall that limits the insertion of nipple portion 88. In this case an infant's lips can go no further than the bottom of channel 96. The flange portion 90 has a thicker portion 98 formed with an annular groove 100. The nipple 86 is generally flat in appearance with the nipple portion 88 extending therefrom centrally. The clamping cap ring 102 fits within the groove 100 to clamp flange 92 to the bottle 104 lip.

The nipple portion 88 has a generally flat circular disc top closure member 106 in which one or more pin hole or slit apertures, such as apertures 40 or 52 as described above in connection with the FIG. 1 and 3 embodiments. A diaphragm 108 having an aperture 110 is located with the nipple portion 88 interior forming liquid receiving chamber 112. Diaphragm 108 is spaced from the bottom of channel 96 to allow placement of the diaphragm slightly past the apex of the infant's lips L. In this embodiment the bottom of channel 96 is about 1.0 in. (2.5 cm) in diameter and is spaced about ¼ in. (0.64 cm) from diaphragm 108.

This nipple works similarly to the embodiments previously described. The nipple portion 88 is fully received within a baby's mouth so that the jaws of the baby may also manipulate and masticate the diaphragm 108. This mastication of the diaphragm may further close the aperture 110 or further open it due to the flexibility of the diaphragm, and how much the nipple portion 88 is squeezed during the sucking action. Some squeezing may open up the aperture 110 while still further squeezing may close it further by simply closing up the chamber 112 due to the nipple portion 88 flexibility. The size of the chamber 112 is set by the axial position of the diaphragm 108 in the cylindrical nipple portion 88.

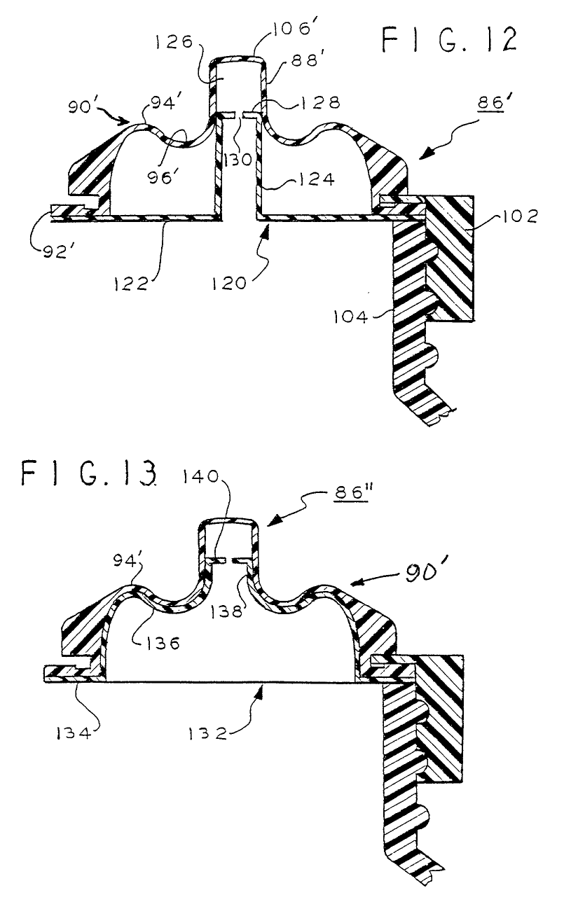

In FIG. 12, a further embodiment comprises a nipple 86′ in which elements corresponding to those in the FIG. 11 embodiment are identified with prime reference numerals. In this embodiment diaphragm member 120 is a separate element which may be removably attached to the nipple 88′. Member 120 comprises an annular disc 122. Disc 122 is clamped to the bottle between flange 92′ and the bottle 104 lip. A circular cylindrical hollow flexible molded pliable diaphragm member 124, e.g., relatively thin thermoplastic or elastomeric material, extends from the disc 122 and is partially positioned within the chamber 126 of the nipple portion 88′. The diaphragm member 124 has an end closure disc 128 with a central aperture 130. The outer diameter of the member 124 is closely received within the chamber 126 sidewall so as to form a fluid seal therewith. The aperture 130 is dimensioned and configured as described with the prior embodiments hereinabove.

When suction is applied to the nipple portion 88′, the diaphragm member is pushed against the interior sidewall of portion 88′ in the chamber 126 further sealing the interface therebetween. Depending upon the size of the opening of aperture 130 the diaphragm disc 128 may be further drawn axially into the chamber 126 reducing its size somewhat. The resulting chamber 126 size determines the volume of liquid in the chamber 126 which is small, as discussed above. These chamber 126 volumes are thus settable in accordance with the axial length of the diaphragm member 124 from the disc 122. Members 120 may be provided in sets of different lengths of members 124 so as to accommodate different baby capacities.

In FIG. 13, nipple 86″ may be identical to the nipple 86′ of FIG. 12. In this embodiment, the diaphragm member 132 is different. The member 132 has an outer flange 134 from which extends an intermediate flange portion 136 which is contoured to fit within the contour of the undulation intermediate flange portion 94′ of the nipple 86″. The member 132 has a central diaphragm member 138. Member 138 is circular cylindrical and in this respect is similar to the member 124 of the FIG. 12 embodiment with an end closure disc 140 with a central aperture as previously described. Member 132, like the other diaphragms, is thin, molded thermoplastic or elastomeric material and is pliable. The axial length of the members 138 may be provided in different values in sets to accommodate different babies. The operation is the same as described in connection with the prior embodiments.

Obviously, many modifications and variations of the present invention are possible in light of the above teachings. It is therefore to be understood that within the scope of the appended claims, the invention may be practiced otherwise than as specifically described.

1. A nursing bottle nipple for insertion past the lips of an infant and into the infant's mouth, the nipple comprising:
a pliable nipple body having a nipple portion and an intermediate portion flaring radially outward from said nipple portion, said intermediate portion being sized and flared to intercept the infant's lips and prevent further insertion of said nipple body into the infant's mouth, said pliable nipple body having a hollow interior having a wide proximal open end and a narrower distal end, the distal end having when undistorted at least one first aperture of a first transverse area for providing fluid communication between the body interior and the body exterior;
an annular flange extending radially outwardly from the intermediate portion of the body at the body proximal open end for securing the body to a nursing bottle; and
a diaphragm in said body interior forming a fluid receiving chamber in said body interior between the diaphragm and the distal end, said diaphragm having a second aperture having when undistorted a second transverse area greater than the first transverse area for providing fluid communication between the proximal end and said chamber, said at least one first aperture and said second aperture each having a maximum transverse area such that each aperture restricts liquid flow therethrough in response to a sucking action on the distal end externally the nipple body to cooperatively limit the flow of liquid therethrough, said diaphragm being spaced distally from said intermediate portion to place said diaphragm between or past the infant's lips.

2. The nipple of claim 1 wherein the body, flange and diaphragm are one piece molded material.

3. The nipple of claim 1 wherein the at least one first aperture comprises a plurality of apertures of substantially the same transverse area.

4. The nipple of claim 1 wherein the at least one first aperture comprises an array of at least three relatively small apertures.

5. The nipple of claim 1 wherein the at least one first aperture comprises a normally closed slit which opens in response to flexure of the body.

6. The nipple of claim 1 wherein the second aperture comprises a circular hole.

7. The nipple of claim 1 wherein the second aperture comprises a slit that is normally closed and wherein the diaphragm is pliable and flexes the slit open in response to flexure thereof, said slit when open forming an opening larger than said at least one first aperture.

8. The nipple of claim 7 wherein the slit comprises a plurality of slits in the diaphragm.

9. The nipple of claim 8 wherein the slits extend radially across the diaphragm in a pie-shaped configuration.

10. The nipple of claim 1 wherein the diaphragm includes a further flange juxtaposed with the annular flange.

11. The nipple of claim 10 wherein the diaphragm includes a conduit portion extending from the further flange, the conduit portion having a restricted end and an open end, the second aperture being disposed in said restricted conduit portion end.

12. The nipple of claim 1 including means for setting the spacing of the diaphragm to the at least one first aperture in the body distal end to thereby set the volume of the chamber to a predetermined value.

13. The nipple of claim 11 wherein the body chamber is circular cylindrical with a given diameter, the conduit portion being circular cylindrical and having a diameter closely received in the chamber to form a fluid seal at the interface of the conduit portion with the body at said chamber.

14. The nipple of claim 1 wherein the body has a cylindrical nipple portion and a flange coupling portion for coupling the nipple portion to the annular flange, the coupling portion including an undulating section between the nipple portion and the annular flange, the nipple portion extending from the coupling portion, and the undulation section having an annular channel extending about said nipple portion.

15. The nipple of claim 1 wherein the chamber holds a maximum of about ⅕ fluid ounce.

16. The nipple of claim 1 wherein the diaphragm tapers from a maximum thickness at said body to a minimum thickness at said second aperture.

17. The nipple of claim 1 wherein the relative areas of the at least one first aperture and the second aperture is such that liquid collects in the chamber in response to said sucking action.

18. The nipple of claim 1 wherein the diaphragm is located in the nipple body such that the diaphragm is subject to distortion forces by mastication by a baby sucking on the nipple.

19. The nipple of claim 1 wherein the diaphragm is located in the nipple body such the diaphragm aperture is subject to increased opening and decreased opening by mastication distortion by a baby sucking on the nipple.

20. A nursing bottle nipple comprising:
a pliable nipple body having a hollow interior with a relatively wide proximal open end and a narrower distal end, the distal end having at least one first aperture of a first transverse area for providing fluid communication between the body exterior and the body interior;
an annular flange extending radially outwardly from the body at the body proximal open end for securing the body to a nursing bottle; and
a partition located in said body interior and forming a liquid receiving chamber in said body between the partition and the distal end, said partition having a second aperture of a second transverse area for providing fluid communication between said chamber and the proximal end, said at least one first aperture and said second aperture each having a maximum transverse area that restricts relative liquid flow through each of said apertures as the liquid flows from the proximal end through the second and at least one first apertures in response to a sucking action on the distal end, such that liquid flow into the chamber through the second aperture cooperatively with the flow from the chamber through the at least one aperture in response to said sucking action such that liquid collects in said chamber.
